(19) United States
(12) Patent Application Publication
(10) Pub. No.: US 2011/0010650 A1
(43) Pub. Date: Jan. 13, 2011

(54) Systems and methods for decluttering electronic map displays

(75) Inventors: Stephen K. Hess, Red Lion, PA (US); James G. Graham, Denver, CO (US); Scott W. Steinke, Denver, CO (US); Corey L. Crawford, Wheat Ridge, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: MapQuest, Inc.

(21) Appl. No.: 12/458,376

(22) Filed: Jul. 9, 2009

(51) Int. Cl. G06F 3/048

(52) U.S. Cl. 715/765; 715/700

(57) ABSTRACT

Systems and methods are provided for decluttering an electronic map display. According to one implementation, a computer-implemented method is provided for decluttering an electronic map display. The method includes receiving information about points-of-interest (POIs) to be represented on the electronic map display, and determining whether icons representative of the POIs would overlap if displayed concurrently. The method further includes grouping the icons that would overlap into at least one overlapping icon group, and displaying on the electronic map a group icon representative of the overlapping icon group.

### BACKGROUND

1. Technical Field

The present disclosure relates generally to the field of computer processing and electronic map displays. More particularly, and without limitation, the disclosure relates to systems and methods for decluttering electronic map displays.

2. Background Information

Today, electronic map displays are widely used to convey information about roads, traffic, buildings, landmarks, terrain, etc. related to a particular geographical region of interest. Because of their versatility, electronic map displays are used in a variety of different computer systems and applications. For example, electronic map displays are used in personal navigation devices to convey driving and/or walking directions to the user. In addition, electronic map interfaces are available from variety of Internet resources (e.g., www.mapquest.com) for use by the public.

Electronic map displays often include interactive features allowing users to, for example, zoom, pan, and/or select displayed information. In addition, electronic map displays sometimes include search interfaces allowing users to enter keywords to search the displayed geographical region for points-of-interest (POI), such as, for example, gas stations, hotels, museums, theme parks, historical sites, or other locations of interest in the geographic area. The search interfaces may also allow users to focus the search to a specific geographical area by entering, for example, a zip code or city.

In general, electronic map displays represent the locations of POIs to users by way of graphic icons. As the number of POIs represented increases, however, electronic map displays may become cluttered and difficult to read. For example, if a user searches for “pizza” in New York City, the number of POI icons shown on the map display may be quite large, rendering the map display unwieldy and difficult to read. At the same time, some POI icons may overlap one another, hiding some information that may be of interest to the user. As such, there is a need to declutter electronic map displays.

One solution for decluttering electronic map displays is disclosed in U.S. patent application Ser. No. 12/246,413, filed Oct. 8, 2008, entitled “Methods and Systems for Decluttering Icons Representing Points of Interest on a Map,” in the names of Pegg et al. (“Pegg”). In Pegg, it is determined whether icons shown in a map view are overlapping and, if so, the overlapping icons are repositioned around a common focal point. In addition, Pegg discloses techniques for drawing leader lines from the repositioned icons to their original locations on the map.

While prior solutions, such as that disclosed in Pegg, may help declutter an electronic map display by clearly conveying information for overlapping icons, the map display may still be cluttered, particularly if the number of overlapping icons is high. Accordingly, there is a need for improved systems and methods for decluttering electronic map displays and, moreover, there is a need for such improved systems and methods that overcome one or more of the problems set forth above.

### SUMMARY

Embodiments of the present disclosure provide systems and methods for decluttering electronic map displays. Embodiments of the present disclosure may be implemented using computer systems and methods, such as those disclosed herein.

One aspect of the disclosure is directed to a computer-implemented method for decluttering an electronic map display. The method may include receiving information about points-of-interest (POIs) to be represented on the electronic map display, and determining whether icons representative of the POIs would overlap if displayed concurrently. The method may further include grouping the icons that would overlap into at least one overlapping icon group, and displaying on the electronic map a group icon representative of the overlapping icon group.

Another aspect of the disclosure is directed to a system for decluttering an electronic map display. The system may include an input device for receiving input from a user and a display device for displaying the electronic map display. The system may further include a processor configured to receive information about points-of-interest (POIs) to be represented on the electronic map display, and to determine whether icons representative of the POIs would overlap if displayed concurrently. The processor may be further configured to group the icons that would overlap into at least one overlapping icon group, and to display on the electronic map a group icon representative of the overlapping icon group.

Yet another aspect of the disclosure is directed to a computer-readable storage medium storing a program which, when executed by a computer, causes the computer to perform a method for decluttering an electronic map display. The method may include receiving information about points-of-interest (POIs) to be represented on the electronic map display, and determining whether icons representative of the POIs would overlap if displayed concurrently. The method may further include grouping the icons that would overlap into at least one overlapping icon group, and displaying on the electronic map a group icon representative of the overlapping icon group.

### BRIEF DESCRIPTION OF THE DRAWINGS

FIG. 1 is a representation of an exemplary electronic map system, consistent with the disclosed embodiments;

FIG. 2 is a representation of the components and information that may be stored in a memory of a client associated with the electronic map system of FIG. 1, consistent with the disclosed embodiments;

FIG. 3 is a representation of the components and information that may be stored in a memory of a server associated with the electronic map system of FIG. 1, consistent with the disclosed embodiments;

FIG. 4 is a flowchart depicting an exemplary method for decluttering an electronic map display, consistent with the disclosed embodiments;

FIG. 5 is a representation of an exemplary cluttered map view, consistent with the disclosed embodiments;

FIG. 6 is a flowchart depicting in greater detail a step in the flowchart of the exemplary embodiment of FIG. 4 of grouping overlapping POI icons into POI icon clusters, consistent with the disclosed embodiments;

FIG. 7 is a flowchart depicting in greater detail a step in the flowchart of the exemplary embodiment of FIG. 6 of deduplicating potential POI icon clusters, consistent with the disclosed embodiments; and

FIG. 8 is a representation of an exemplary decluttered map view, consistent with the disclosed embodiments.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

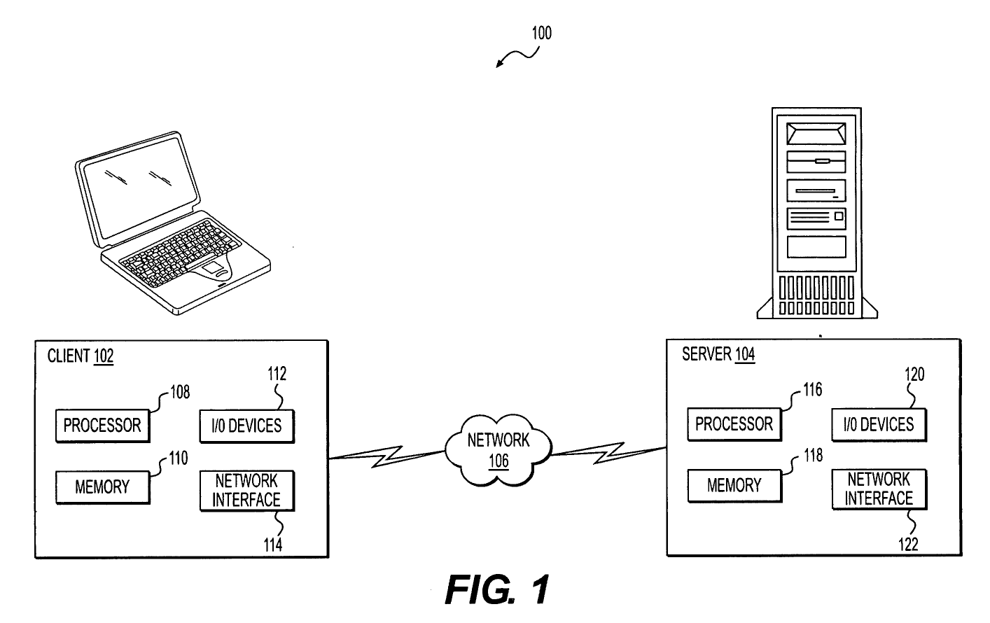

FIG. 1 is a representation of an exemplary electronic map system 100, consistent with the disclosed embodiments. System 100 may include a client 102 and a server 104 connected via a network 106. By way of non-limiting example, client 102 may comprise a personal computer, a hand-held computer, a personal digital assistant, a portable navigation device, a mobile phone, and/or another computing device known in the art. Client 102 may include a processor 108, a memory 110, one or more input/output devices 112, and a network interface 114 for communicating on network 106.

Processor 108 may comprise one or more processors (e.g., a CPU) configured to execute instructions and to process data to perform one or more functions associated with system 100. Processor 108 may be configured to execute instructions to perform the disclosed processes.

Memory 110 may comprise one or more memory devices that store data, such as, for example, random access memory (RAM), read-only memory (ROM), a magnetic storage device (e.g., a hard disk), an optical storage device (e.g., a CD- or DVD-ROM), an electronic storage device (e.g., EPROM or a flash drive), and/or another other data storage devices known in the art. Memory 110 may store one or more applications for performing the disclosed processes, which may be executed by processor 108. The applications may be implemented using applets, plug-ins, modules, and/or any other software components known in the art.

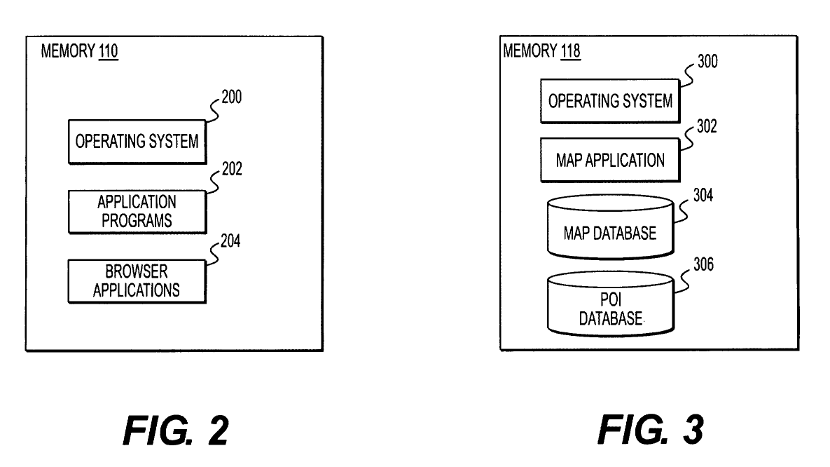

FIG. 2 is a representation of the components and information that may be stored in client memory 110 in further detail, consistent with the disclosed embodiments. As shown, memory 110 may store an operating system 274, such as DOS, Windows, or Linux. Memory 110 may also include one or more application programs 202, such as word processing, database programs, spreadsheet programs, presentation programs, and graphics programs, and/or other programs capable of generating documents or other electronic content. Memory 110 may also include browser applications 204 capable of rendering standard Internet content, such as Netscape Navigator, Microsoft Internet Explorer, and/or Mozilla Firefox. Processor 108 may leverage and execute operating system 200, application programs 202, and/or browser applications 204 in connection with the disclosed processes.

Input/output devices 112 may include one or more components allowing a user of system 100 to interface with client 102. For example, input/output devices 112 may include user input devices such as a keyboard, a keypad, a mouse, a touch pad, a touch screen, a microphone, an accelerometer, and/or any other user input device known in the art. Input/output devices 112 may also include output devices such as a display (e.g., an LCD, a CRT display, or a plasma display), a printer, a speaker, and/or any other output device known in the art.

Network interface 114 may comprise any communication device for sending and receiving data. For example, network interface 114 may include a modem, a transceiver, a set-top box, a network communication card, a satellite dish, an antenna, or another network adapter capable of transmitting and receiving data over network 106.

Server 104 may comprise a personal computer, a mainframe computer, and/or any other server computing device known in the art. Similar to client 102, server 104 may include a processor 116, a memory 118, input/output devices 120, and/or a network interface 122 for communicating on network 106. The components of server 104 may be the same or similar to those discussed above in connection with client 102 and, accordingly, discussion thereof is omitted. Server 104 may respond to request from client 102 received from network 106 in connection with the disclosed processes. It is noted that server 104 may comprise a single server computer or a collection of server computers, alone or in combination with other components, such as a global positioning system (GPS) (not shown). For example, server 104 may be part of a distributed server network (not shown) and may distribute data for parallel processing to one or more additional servers on the distributed server network.

FIG. 3 is a representation of the components and information that may be stored in server memory 118 in further detail, consistent with the disclosed embodiments. As shown, memory 118 may include an operating system 300, a map application 302, a map database 304, and a points-of-interest (POI) database 306.

Map application 302 may comprise one or more electronic mapping applications configured to render map displays based on stored map data and user input. Map database 304 may contain cartographic information, geographic information, road information, satellite image information, traffic information and/or other information about one or more geographical regions of interest. Points-of-interest database 306 may contain address information, latitude/longitude information, ID numbers, website addresses, descriptive information, and/or other information about various points-of-interest within the geographical regions of interest. Processor 116 may leverage and execute operating system 300, map application 302, map database 304, and/or POI database 306 in connection with the disclosed processes.

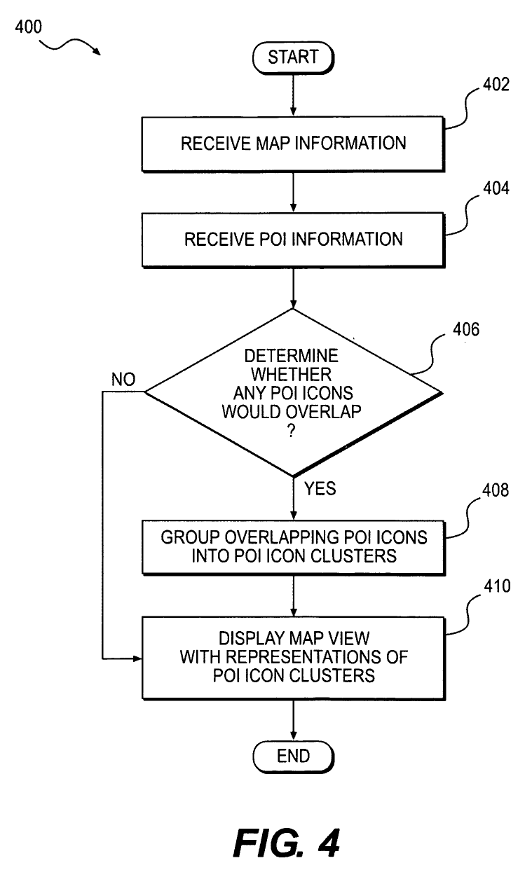

FIG. 4 is a flowchart depicting a an exemplary method 400 for decluttering an electronic map display, consistent with the disclosed embodiments. Decluttering method 400 may be performed based on, for example, program modules stored in client memory 110 and/or server memory 118. Although decluttering method 400 is described below as being performed primarily by server 104, it is to be appreciated that decluttering method 400 may be performed by client 102 and server 104 individually or in combination. For example, client 102 may perform decluttering method 400 based on data provided by server 104, or server 104 may perform decluttering method 400 based on data provided by client 102. Alternatively, client 102 and server 104 may each perform different portions of decluttering method 400 in tandem.

At step 402, server 104 may receive map information. For example, a user at client 102 may access a mapping application associated with server 104 by entering a domain name or uniform resource locator (URL) into a Web browser application (e.g., www.mapquest.com). The user may then request map information for a particular geographical region of interest by, for example, entering a city name, an address, or other information into the mapping application as a search key. Alternatively or additionally, the user may request map information for a particular geographical region of interest by providing input directly to a map interface associated with the mapping application (e.g., zooming, panning, etc.). Running map application 302, server 104 may then retrieve the appropriate map information from map database 304, render a map display based on the map information, and provide the map display to client 102 via network 106. Server 104 may display the map information as a map view, or a portion of an overall map that is displayed and viewable to the user.

At step 404, server 104 may receive POI information for locations in the map view. For example, the user may enter a search key (e.g., “Holiday Inn,” “pizza,” etc.) into a search interface provided by the mapping application. Server 104 may then search POI database 306 based on the search key, and may retrieve POI information (e.g., latitude and longitude information, name, address, icon graphic information, etc.) corresponding to each of the POIs identified the search that are located within the map view. Server 104 may then send the POI information to client 102 for display to the user.

At step 406, server 104 may determine whether any icons representing the POIs identified in step 404 would overlap if displayed concurrently in the map view. For purposes of this disclosure, “overlapping” may mean that the POI icons would overlap one another by at least one pixel if displayed concurrently on a map display in their corresponding geographical locations. If it is determined in step 406 that some POI icons would overlap, processing may proceed to step 408. Otherwise processing may end.

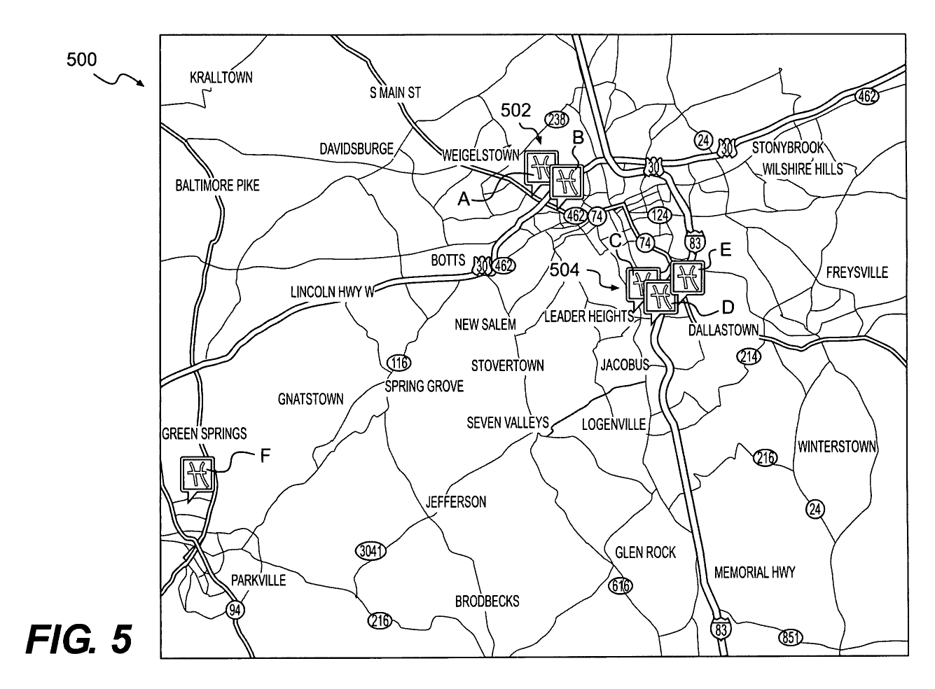

FIG. 5 is a representation of an exemplary cluttered map view 500, consistent with the disclosed embodiments. Map view 500 displays a first set 502 of overlapping POI icons A and B, a second set 504 of overlapping POI icons C, D, and E, and a lone POI icon F. In the exemplary illustration, POI icons A-F correspond to exemplary Holiday Inn hotels located within the greater York, PA region. It is noted, however, that map view 500 may correspond to any geographical area of interest, and POI icons A-F may correspond to any POIs located within that area of interest. It is also to be appreciated that whether POI icons A-F would overlap in map view 500 may depend on the particular geographical locations (i.e., latitude and longitude) of the POIs, the current zoom level of map view 500, the dimensions of POI icons A-F, and/or other factors. For example, if map view 500 were zoomed out to the national level, all of POI icons A-F may overlap on another. Accordingly, server 104 may determine whether any of POI icons A-F would overlap based on the dimensions of POI icons A-F, the geographical locations of POI icons A-F, the zoom level of map view 500, and/or other factors.

In step 408, if server 104 determines in step 406 that at least two POI icons would overlap if displayed concurrently in the map view, server 104 may group the overlapping POI icons into POI icon clusters. By clustering the POI icons and displaying a single POI icon representing the cluster as described below, the information clutter in map view 500 may be reduced.

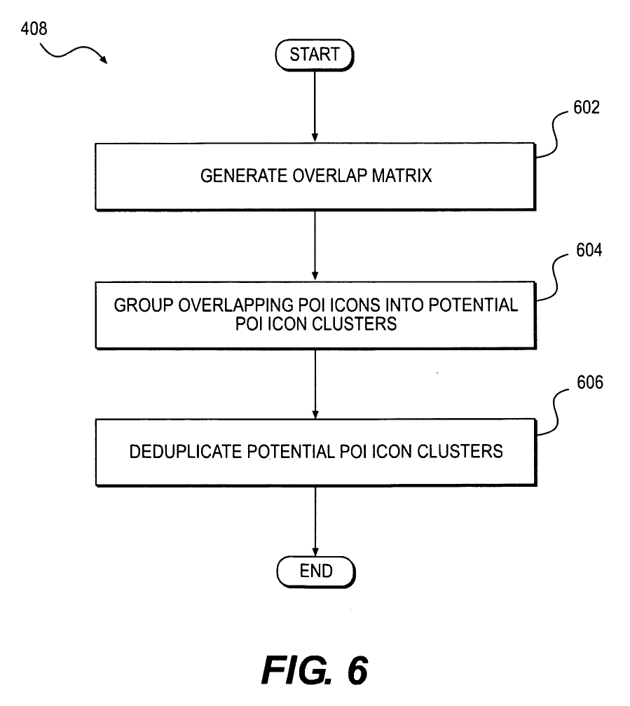

FIG. 6 is a flowchart depicting in greater detail step 408 (FIG. 4), consistent with the disclosed embodiments. Initially, in step 602, server 104 may generate an n by n overlap matrix, where n is the number of POI icons to be represented in the map view. The rows and columns of the overlap matrix may each correspond to the different POI icons to be represented in the map view. Each entry in the overlap matrix may contain a “1” or a “0” (i.e., true or false) indicating whether the two respective POI icons were determined in step 406 to overlap. For example, an overlap matrix for FIG. 5 may have a total of six rows and six columns, as there are a total of six POI icons A-F to represent in map view 500. As such, an exemplary overlap matrix 0 for FIG. 5 may be as follows:

$$O = \begin{matrix}A \\ B \\ C \\ D \\ E \\ F\end{matrix} {[ \begin{matrix}0 & 1 & 0 & 0 & 0 & 0 \\ 1 & 0 & 0 & 0 & 0 & 0 \\ 0 & 0 & 0 & 1 & 0 & 0 \\ 0 & 0 & 1 & 0 & 1 & 0 \\ 0 & 0 & 0 & 1 & 0 & 0 \\ 0 & 0 & 0 & 0 & 0 & 0\end{matrix} ]}^{\begin{matrix}A & B & C & D & E & F\end{matrix}} .$$

In overlap matrix O, row 1, column 2 and row 2, column 1 may each contain a “1”, as POI icons A and B overlap; row 3, column 4 may contain a “1”, as POI icon C overlaps with POI icon D; row 4, columns 3 and 5 may each contain a “1”, as POI icon D overlaps with both POI icon C and POI icon E; and row 5, column 4 may contain a “1” as POI icon E overlaps with POI icon D. Because POI icon F does not overlap with any other icon, each entry in row 6 may contain a “0”. It is also noted that since a POI icon cannot overlap itself, each of rows n, columns n may contain a “0”.

In step 604, server 104 may group the overlapping POI icons into potential POI icon clusters. As used herein, a “POI icon cluster” may refer to any group of two or more overlapping POI icons. Specifically, server 104 may search the rows of overlap matrix O to identify all overlaps (i.e., all “1”s) among the POI icons. For each row that contains at least one “1”, server 104 may form a potential POI icon cluster containing the POI icon corresponding to the row and the POI icon corresponding to the column(s) containing a “1”. For example, based on the overlap matrix O above, server 104 may generate a POI icon cluster AB for row 1 containing POI icons A and B; a POI icon cluster BA for row 2 containing POI icons B and A; a POI icon cluster CD for row 3 containing POI icons C and D; a POI icon cluster DCE for row 4 containing POI icons D, C, and E; and a POI icon cluster ED for row 5 containing POI icons E and D. No icon cluster may be generated for row 6, as POI icon F does not overlap any other POI icons. Each of the POI icon clusters generated in step 604 may be stored in memory for further processing described below.

It is noted that, upon completion of step 604, a POI icon may belong to more than one potential POI icon cluster. In the example above, POI icon A belongs to both of POI icon clusters AB and BA; POI icon B belongs to both of POI icon clusters AB and BA; POI icon C belongs to both of POI icon clusters CD and DCE; POI icon D belongs to both of POI icon clusters CD and DCE; and POI icon E belongs to both of POI icon clusters DCE and ED. Accordingly, in step 606, server 104 may deduplicate the potential POI icon clusters identified in step 604. That is, server 104 may remove each POI icon from all but one of the potential POI icon clusters. The purpose of step 606 may be to ensure that a POI icon is not redundantly represented by multiple POI cluster icons, which are discussed below in further detail.

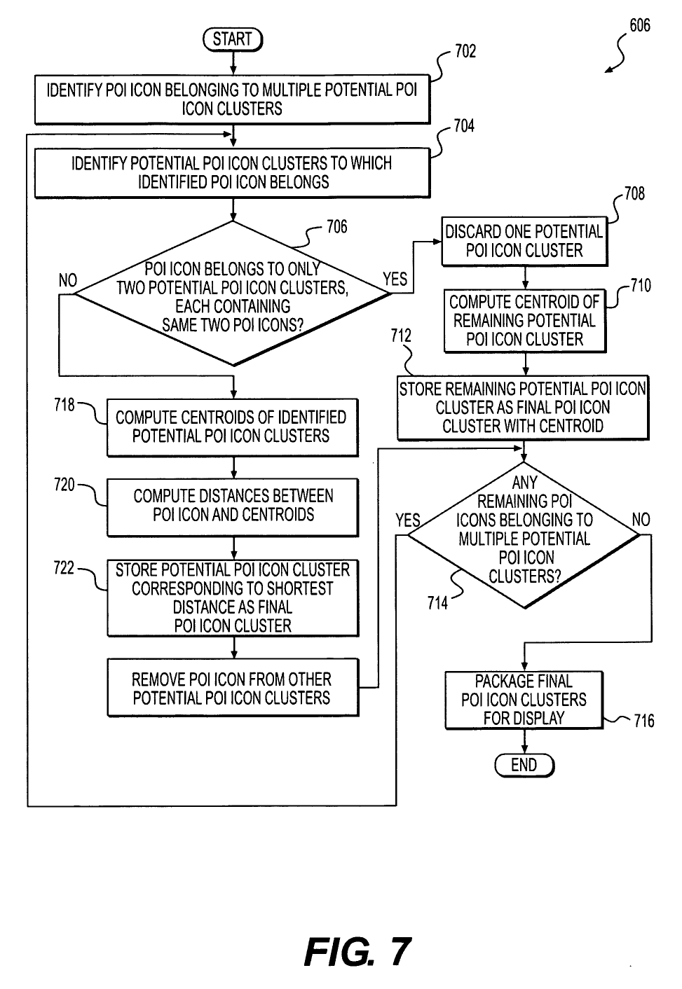

FIG. 7 is a flowchart depicting in greater detail step 606 (FIG. 6), consistent with the disclosed embodiments. In step 702, server 104 may identify a POI icon that belongs to more than one of the potential POI icon clusters identified in step 604. Specifically, server 104 may search the rows of overlap matrix O to identify each column containing a “1”. Then, for each column containing a “1”, server 104 may search the row of overlap matrix O corresponding to that column. If that row also contains a “1”, server 104 may determine that the POI icon corresponding to the initial row belongs to more than one POI icon cluster. Continuing with the above example, server 104 may search row 1 and determine that column 2 contains a “1”. Then server 104 may search row 2 and determine that row 2 also contains a “1”. Based on this, server 104 may determine that POI icon A belongs to two potential POI icon clusters.

In step 704, server 104 may identify all of the potential POI icon clusters to which the POI icon identified in step 702 (“subject POI icon”) belongs based on overlap matrix O. As used herein, “potential POI icon cluster,” means an icon cluster that may or may not be represented on a map display by a group POI icon. For example, a potential POI icon cluster may later be discarded or modified (e.g., if duplicative with another potential POI icon cluster). Server 104 may then store in memory a potential POI icon cluster vector identifying all potential POI icon clusters to which the subject POI icon belongs. An exemplary potential POI icon cluster vector for POI icon A may be <AB, BA>. An exemplary potential POI icon cluster vector for POI icon D may be <CD, DCE>.

In step 706, server 104 may determine whether the subject POI icon belongs to only two potential POI icon clusters, each containing the same two POI icons. For example, server 104 may determine whether the POI icon cluster vector for the POI icon contains only contain only two POI icons, and whether each POI icon cluster contains the same two POI icons (e.g., AB and BA). If so, server 104 may discard one of the two potential POI icon clusters in step 708.

Then, in step 710, server 104 may compute the centroid of the POI icons contained in the remaining potential POI icon cluster based on latitude and longitude information for those POI icons. For example, server 104 may compute the centroid of the POI icons contained in the remaining potential POI icon cluster according to the following equations:

$${LNG}_{C} = \frac{{LNG}_{1} + {LNG}_{2}}{2} ; and$$

$${LAT}_{C} = \frac{{LAT}_{1} + {LAT}_{2}}{2} ,$$

where LNG_{C} represents the longitudinal coordinate of the centroid of the remaining potential POI icon cluster, and LNG₁ and LNG₂ respectively represent the longitudinal coordinates of the POIs corresponding to the first and second POI icons contained in the remaining potential POI icon cluster. Similarly, LAT_{C} represents the latitudinal coordinate of the centroid of the remaining potential POI icon cluster, and LAT₂ and LAT₂ respectively represent the latitudinal coordinates of the POIs associated with the first and second POI icons contained in the remaining potential POI icon cluster.

In step 712, server 104 may store the remaining potential POI icon cluster as a final POI icon cluster having as its location the centroid computed in step 710. A final POI icon cluster may be stored as a vector of the form:

<POI₁, POI₂, LAT_{C}, LNG_{C}>,

where POI₁ and POI₂ are identifiers for the first and second POI icons in the final POI icon cluster, and LAT_{C} and LNG_{C} are respectively the latitude and longitude of the centroid of the final POI icon cluster.

In step 714, server 104 may determine whether there are any remaining POI icons that belong to more than one potential POI icon cluster, as discussed above with respect to step 704. If not, processing may proceed to step 716, in which server 104 may package all final POI icon clusters for display. For example, server 104 may retrieve any final POI icon cluster vectors stored in memory, and may format the information for display. In one embodiment, server 104 may generate a markup language document (e.g., XML, HTML, etc.) containing display information for each of the final POI icon clusters. The document may also contain display information for any lone (i.e., single) POI icons to be displayed. The document may contain, for each POI icon cluster to be displayed, IDs for each of the POI icons contained in the cluster, longitudinal and latitudinal coordinates for a bounding rectangle for the cluster, longitudinal and latitudinal coordinates for the centroid of the cluster, and/or any other information for displaying a POI icon representation of the cluster. The document may contain similar information for the lone POI icons to be displayed. Then, the display information for the final POI icon clusters and lone POI icons may be rendered by map application 302 (FIG. 3) and sent to client 102 for display.

If server 104 determines in step 714 that there is a remaining POI icon that belongs to more than one potential POI icon cluster, however, processing may return to step 704. Server 104 then may repeat step 704 with respect to the remaining POI icon.

If server 104 determines in step 706 that the subject POI icon does not belong to only two potential POI icon clusters, which each cluster containing the same two POI icons, server 104 may proceed to step 718. In step 718, server 104 may compute the centroids of the potential POI icon clusters identified in step 704. Specifically, server 104 calculate the centroids of each of the potential POI icon clusters based on the latitude and longitude information of each of the POIs corresponding to POI icons contained in the potential POI icon clusters. In one embodiment, the subject POI icon may be left out of the centroid computations. The centroids of the potential POI icon clusters may be calculated according to the following formulas:

$${LNG}_{C} = \frac{{LNG}_{1} + {LNG}_{2} + … + {LNG}_{k}}{k} ; and$$

$${LAT}_{C} = \frac{{LAT}_{1} + {LAT}_{2} + … + {LAT}_{k}}{k} ,$$

where LAT_{C} represents the longitudinal coordinate of the centroid of the potential POI icon cluster, LNG₁-LNGₖ respectively represent the longitudinal coordinates of the POIs associated with the POI icons contained in the potential POI icon cluster (except for the subject POI icon), and k represents the total number of POI icons contained in the potential POI icon cluster. Similarly, LNG_{C} represents the latitudinal coordinate of the centroid of the potential POI icon cluster, LAT₁-LATₖ respectively represent the latitudinal coordinates of the POIs associated with the POI icons contained in the potential POI icon cluster (except for the subject POI icon), and k represents the total number of POI icons contained in the potential POI icon cluster.

In step 720, server 104 may compute the respective distances between the location of the POI associated with the subject POI icon and the centroids of the potential POI icon clusters computed in step 718. For example, server 104 may compute the distances according to the following formula:

d_{c}=\sqrt{(LAT_{POI}−LAT_{C})̂2+(LNG_{POI}−LNG_{C})̂2},

where d_{c} represents the distance from the POI associated with the subject POI icon to the centroid of the potential POI icon cluster, LAT_{POI} represents the latitudinal coordinate of the POI associated with the subject POI icon, LNG_{POI} represents the longitudinal coordinate of the POI associated with the subject POI icon, LAT_{C} represents the latitudinal coordinate of the centroid of the potential POI icon cluster (as computed above in step 718), and LNG_{C} represents the longitudinal coordinate of the centroid of the potential POI icon cluster (as computed above in step 718).

In step 722, server 104 may store as a final POI icon cluster the potential POI icon cluster to which the subject POI icon has the shortest distance. As used herein, a “final POI icon cluster,” as distinguished from a “potential POI icon cluster,” may refer to a selected group of overlapping icons that will be represented on a map display by a single, group POI icon. Specifically, in step 722, server 104 may determine the shortest of the distances computed in step 720, and may store in memory the corresponding potential POI icon cluster as a final POI icon cluster. The final POI icon cluster may be stored as a vector of the form:

<POI₁, POI_{2, . . . , POI}_{N}, C_{LAT}, C_{LNG}>,

where POI₁, POI₂, . . . POI_{N} are identifiers for each of the POI icons contained in the final POI icon cluster, and C_{LAT} and C_{LNG} are respectively the latitude and longitude coordinates of the centroid of the final POI icon cluster, as computed above in step 718.

Next, in step 724, server 104 may remove the subject POI icon from all other potential POI icon clusters. In this manner, each POI icon may be contain in only a single final POI icon cluster. Then processing may return to step 714.

Returning to FIG. 4, in step 410, client 102 may display a decluttered map view based on the display information packaged in step 716. That is, client 102 may display representations of any final POI icon clusters identified in steps 712 and 722 discussed above, as well as of any lone POI icons (i.e., POI icons not belonging to a cluster) remaining after the grouping of step 408 has been completed. If it is determined in step 406 that no POI icons would overlap, processing may simply skip to step 410 and display a map view without grouping the POI icons as discussed above in connection with step 408.

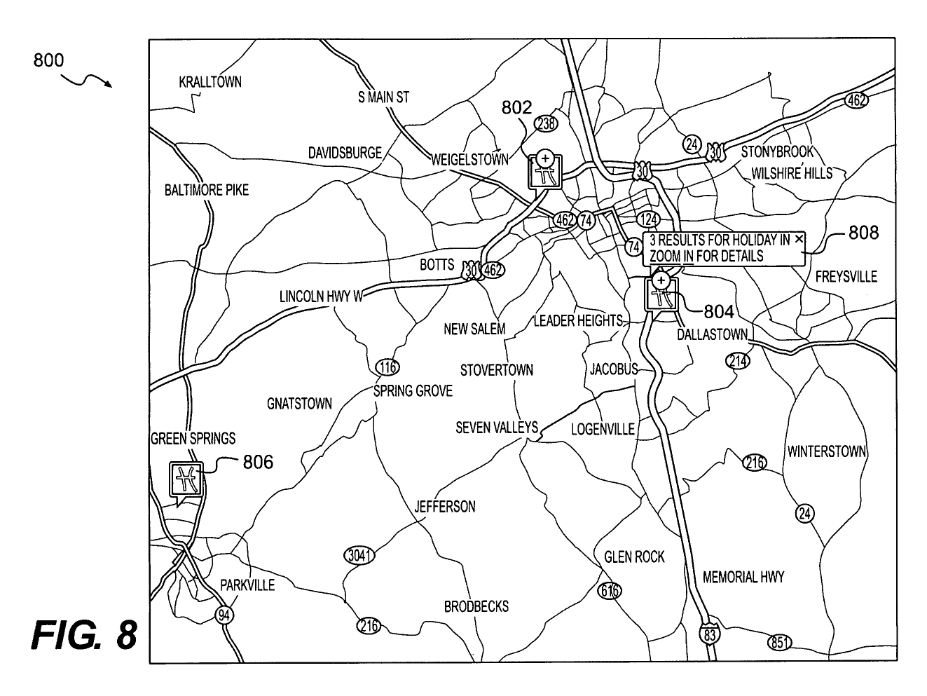

FIG. 8 depicts illustrates an exemplary decluttered map view 800 displayed by client 102, consistent with the disclosed embodiments. Map view 800 may include a first POI cluster icon 802, a second POI cluster icon 804, and a lone POI icon 806. First and second POI cluster icons 802 and 804 may correspond to the final POI icon clusters identified in step 722 and packaged for display in step 716 above (FIG. 7). It is noted that decluttered map view 800 may correspond to a decluttered version of map view 500 (FIG. 5). Specifically, first POI cluster icon 802 may correspond to first set 502 of overlapping POI icons A and B, and second POI cluster icon 804 may correspond to second set 504 of overlapping POI icons C, D, and E. Lone POI icon 806 may correspond to POI icon F. In one embodiment, first and second POI cluster icons 802 and 804 may be displayed within map view 800 at the computed centroids of their corresponding POI icon clusters.

As shown in the exemplary embodiment of FIG. 8, first and second POI cluster icons 802 and 804 may each include a visually distinguishing feature indicating that first and second POI cluster icons 802 and 804 represent multiple POIs. In one embodiment, the visually distinguishing feature may be a “+” symbol. It is to be appreciated, however, POI cluster icons 802 and 804 may be indicated or distinguished from a “normal” POI icon representing only a single POI (e.g., POI icon 806) in any suitable manner. For example, a different type icon may be used for POI cluster icons 802 and 804 than for single POIs, if desired.

In addition, when the user at client 102 “rolls over”, clicks, or otherwise selects first or second POI cluster icons 802, 804, additional information about the POIs may be displayed. For example, in one embodiment, an associated information bubble 808 containing additional information about the POI cluster icon may be displayed near the POI cluster icon. Such additional information may include, for example, an indication that the POI cluster icon represents multiple POIs, the number of POIs represented by the POI cluster icon, a link to a website associated with one or more of the POIs, an option to zoom in further, etc.

It is to be appreciated that whether POI icons 802-806 overlap in map view 800 may depend on the current zoom level for map view 800. Accordingly, if the user adjusts the zoom level (i.e., zooms in or out), the processing steps discussed above with respect to FIGS. 4, 6, and 7 may be repeated, map view 800 may be updated.

By implementing embodiments of this disclosure, electronic map displays may be decluttered and thereby made easier to read for end users. Specifically, by identifying POI icons that would overlap one another if displayed concurrently in a particular map view and displaying a representative POI cluster icon instead of the overlapping POI icons, clutter in the map view may be reduced. Accordingly, a user may have an easier time gleaning information from the map view. In addition, while clutter is reduced, the amount of information the user can glean from the map display is not compromised.

One skilled in the art will appreciate that computer programs for implementing the disclosure may be stored on and/or read from computer-readable storage media. The computer-readable storage media may have stored thereon computer-executable instructions which, when executed by a computer, cause the computer to perform, among other things, the processes disclosed herein. Exemplary computer-readable storage media may include magnetic storage devices, such as a hard disk, a floppy disk, magnetic tape, or another magnetic storage device known in the art; optical storage devices, such as CD-ROM, DVD-ROM, or another optical storage device known in the art; and/or electronic storage devices, such as EPROM, a flash drive, or another integrated circuit storage device known in the art. The computer-readable storage media may be embodied by or in one or more components of electronic map system 100 (FIG. 1).

One skilled in the art will further realize that the processes illustrated in this description may be implemented in a variety of ways and may include multiple other modules, programs, applications, scripts, processes, threads, or code sections that may all functionally interrelate to accomplish the individual tasks described above. For example, it is contemplated that these programs modules may be implemented using commercially available software tools, using custom object-oriented code written in the C++programming language, using applets written in the Java programming language, or may be implemented as with discrete electrical components or as one or more hardwired application specific integrated circuits (ASIC) custom designed for this purpose. In addition, the disclosure may be implemented in a variety of different data communication network environments and may use software, hardware, or a combination of hardware and software to provide the disclosed functions.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. It is intended that the specification and examples be considered as exemplary only, with a true scope and spirit of the invention being indicated by the following claims.

What is claimed is:

1. A computer-implemented method for decluttering an electronic map display, the method comprising:
receiving information about points-of-interest (POIs) to be represented on the electronic map display;
determining whether icons representative of the POIs would overlap if displayed concurrently;
grouping the icons that would overlap into at least one overlapping icon group; and
displaying on the electronic map a group icon representative of the overlapping icon group.

2. The method of claim 1, wherein the information about the POIs includes latitude and longitude information for the POIs.

3. The method of claim 2, further comprising computing a centroid of POIs associated with the overlapping icon group based on the latitude and longitude information, wherein the group icon is displayed at the determined centroid.

4. The method of claim 2, wherein grouping the icons further comprises:
identifying an icon contained in two or more overlapping icon groups;
computing, based on the latitude and longitude information, distances from a POI associated with the icon to centroids of the POIs associated with each of the two or more icon groups; and
grouping the icon in the overlapping icon group corresponding to the shortest distance.

5. The method of claim 4, further comprising removing the icon from the other overlapping icon groups.

6. The method of claim 1, further comprising visually distinguishing the group icon from an icon representative of only a single POI.

7. The method of claim 6, further comprising displaying information about the POIs represented by the group icon when a user selects the group icon.

8. A system for decluttering an electronic map display, the system comprising:
an input device for receiving input from a user;
a display device for displaying the electronic map display;
a processor configured to:
receive information about points-of-interest (POIs) to be represented on the electronic map display;
determine whether icons representative of the POIs would overlap if displayed concurrently;
group the icons that would overlap into at least one overlapping icon group; and
display on the electronic map a group icon representative of the overlapping icon group.

9. The system of claim 8, wherein the information about the POIs includes latitude and longitude information for the POIs.

10. The system of claim 9, wherein the processor is further configured to:
compute a centroid of POIs associated with the overlapping icon group based on the latitude and longitude information; and
display the group icon is at the determined centroid.

11. The system of claim 9, wherein the processor is further configured to:
identify an icon contained in two or more overlapping icon groups;
compute, based on the latitude and longitude information, distances from a POI associated with the icon to centroids of the POIs associated with each of the two or more icon groups; and
group the icon in the overlapping icon group corresponding to the shortest distance.

12. The system of claim 11, further comprising removing the icon from the other overlapping icon groups.

13. The system of claim 8, wherein the processor is further configured to visually distinguish the group icon from an icon representative of only a single POI on the electronic map display.

14. The system of claim 13, wherein the processor is further configured to display information about the POIs represented by the group icon when a user selects the group icon.

15. A computer-readable storage medium storing a program which, when executed by a computer, causes the computer to perform a method for decluttering an electronic map display, the method comprising:
receiving information about points-of-interest (POIs) to be represented on the electronic map display;
determining whether icons representative of the POIs would overlap if displayed concurrently;
grouping the icons that would overlap into at least one overlapping icon group; and
displaying on the electronic map a group icon representative of the overlapping icon group.

16. The computer-readable storage medium of claim 15, wherein the information about the POIs includes latitude and longitude information for the POIs.

17. The computer-readable storage medium of claim 16, wherein the method further comprises computing a centroid of POIs associated with the overlapping icon group based on the latitude and longitude information, wherein the group icon is displayed at the determined centroid.

18. The computer-readable storage medium of claim 16, wherein grouping the icons further comprises:
identifying an icon contained in two or more overlapping icon groups;
computing, based on the latitude and longitude information, distances from a POI associated with the icon to centroids of the POIs associated with each of the two or more icon groups; and
grouping the icon in the overlapping icon group corresponding to the shortest distance.

19. The computer-readable storage medium of claim 18, wherein the method further comprises removing the icon from the other overlapping icon groups.

20. The computer-readable storage medium of claim 15, wherein the method further comprises:
visually distinguishing the group icon from an icon representative of only a single POI; and
displaying information about the POIs represented by the group icon when a user selects the group icon.
